(19) United States
(12) Patent Application Publication
(10) Pub. No.: US 2010/0109963 A1
(43) Pub. Date: May 6, 2010

(54) Sealing an Antenna System

(76) Inventors: Klaus Kienzle, Zell am Harmersbach (DE); Josef Fehrenbach, Haslach (DE); Juergen Motzer, Gengenbach (DE)

Correspondence Address: FAY KAPLUN & MARCIN, LLP, 150 BROADWAY, SUITE 702, NEW YORK, NY, 10038, US

(21) Appl. No.: 12/431,985

(22) Filed: Apr. 29, 2009

Related U.S. Application Data
(60) Provisional application No. 61/051,402, filed on May 8, 2008.

(30) Foreign Application Priority Data
May 8, 2008 (EP) 08 155 923.9

(51) Int. Cl. H01Q 13/02; H01P 1/04

(52) U.S. Cl. 343/786; 333/254

(57) ABSTRACT

An adaptation apparatus comprises a closing-off body and an enlargement. The closing-off body comprises a generated surface which is adapted to establish contact with an external conductor of a waveguide. The enlargement is arranged on the generated surface. The enlargement is adapted such that the enlargement spaces apart an electrical short circuit at a predetermined space from the generated surface of the closing-off body.

### REFERENCE TO RELATED APPLICATIONS

This application claims the benefit of the filing date of U.S. Provisional Patent Application Ser. No. 61/051,402 filed on May 8, 2008 and EP Patent Application Serial No. EP 08 155 923.9 filed on May 8, 2008, the disclosures of which are hereby incorporated herein by reference.

### FIELD OF THE INVENTION

The present invention relates to the field of measuring technology, in particular fill-level measuring technology, pressure measuring technology and limit-level measuring technology. In particular, the present invention relates to an adaptation apparatus, an antenna arrangement, a measuring device and a method for closing off respectively sealing a waveguide (Wellenleiter).

### TECHNOLOGICAL BACKGROUND

Waveguides can be implemented as hollow conductors and wave ducts, respectively. In a hollow conductor that is stimulated in a mode an electromagnetic wave can arise which makes it possible to transmit information.

Document U.S. Pat. No. 5,872,494 may describe a waveguide assembly comprising a first waveguide portion with a first waveguide bore, and a second waveguide portion, attached to the first waveguide portion and comprising a second waveguide bore that is axially aligned with the first waveguide bore. Furthermore, the waveguide assembly comprises a mechanical barrier with a first shaft section, arranged in the first waveguide section, a second shaft section, arranged in the second waveguide section, and a raised annular shoulder, arranged in a process sealing cavity, wherein the raised annular shoulder has a width, which extends radially outward from an outside diameter of the shaft section to approximately λ_{G}/2, and has a height, which extends axially between the first and second waveguide sections, of approximately ¼ λ_{G}.

Furthermore, antenna systems with an adaptation apparatus that is radially sealed may be known.

There may be a need to provide for an efficiently closing off of a waveguide.

### SUMMARY OF THE INVENTION

According to an exemplary embodiment of the present invention an adaptation apparatus, an antenna arrangement, a measuring device and a method for closing off a waveguide may be created.

An adaptation apparatus may comprise an adaptation cone. The adaptation cone can also be referred to as a closing-off apparatus or closing-off body. The adaptation cone may, for example, be made from PTFE (polytetrafluoroethylene), on which a radial enlargement and expanded section, respectively may be attached. If the adaptation cone may not comprise an enlargement, the adaptation cone on its own may be referred to as the adaptation apparatus. It may also be possible to form this radial enlargement such that essentially by forming the radial enlargement a sealing effect can be achieved. By this forming the use of an additional sealing element or an additional sealing device, such as an O-ring, can thus be avoided. A groove or a plurality of grooves or at least fluting may be provided on the radial enlargement as a form and formation, respectively by which a sealing effect may be achievable.

The adaptation apparatus or the adaptation element may be used to essentially close off an opening or bore of a waveguide, and at the same time to adapt a frequency response or a frequency characteristic of an arrangement of waveguides with an adaptation apparatus in such a way that for a predetermined frequency the arrangement may have a low attenuation, and for this wavelength may reflect essentially only a portion of the wave, which portion may be as small as possible.

An additional sealing element that may be axially affixed to the radial enlargement of the adaptation cone may increase the sealing effect. This sealing element can also be designated a sealing ring or sealing device. Imaginable sealing elements may be an O-ring, a flat seal, a wave seal or a combined seal (metal-plastic).

“Radial sealing” may refer to a sealing which may be arranged on the outside, i.e. on the generated surface, the superficies surface and lateral surface (Mantelfläche), respectively of a cylinder or a cone along the radius of the part to be sealed off. As an alternative, a radial sealing may be arranged in a deepening groove of the part to be sealed. Radial sealing may thus refer to sealing that may take place on the outside of a cylinder or a cone along the radius of the part to be sealed.

“Axial sealing” may refer to a sealing that may be arranged on a radial enlargement. In other words, axial sealing may refer to sealing that may take place on a radial enlargement. On the radial enlargement the seal then may be affixed in axial direction on one side or both sides. Axial sealing may take place along a direction of propagation of an electromagnetic wave, i.e. an axial sealing may be positioned in a direction of propagation of the electromagnetic wave in front of or behind the radial enlargement.

Or in other words, an axially arranged sealing may prevent a material flow that would move in radial direction of an adaptation apparatus, i.e. in perpendicular direction to the longitudinal axis of the adaptation apparatus.

A radially arranged sealing may prevent a material flow that would move parallel to a longitudinal axis of the adaptation apparatus.

With an axial arrangement of a sealing ring, i.e. an axial sealing, a waveguide may be able to be provided, in particular an antenna system for a fill level radar may be able to be provided, in which waveguide or in which antenna system the sealing ring features a small design and wherein the sealing ring may be suitable for sealing the waveguide. Furthermore, the sealing ring may comprise little influencing of electrical signals, in particular electromagnetic waves. In other words, the sealing ring may have low attenuation to electromagnetic waves.

A radial enlargement, shoulder or collar of the adaptation apparatus may be referred to as an “HF choke” (high frequency choke). The adaptation apparatus can comprise an angular, edged or oval form.

According to an aspect of the present invention, an adaptation apparatus may be created that may comprise a closing-off body and an enlargement, wherein the closing-off body may comprise a generated surface that may be adapted to establish contact with an external conductor of a waveguide. The enlargement may be arranged on the generated surface and may form a predetermined space between a short circuit and the generated surface of the closing-off body.

According to a further aspect of the present invention, an antenna arrangement may be created that may comprise a hollow conductor, an antenna horn and an adaptation apparatus according to the invention. The adaptation apparatus may be arranged between the hollow conductor and the antenna horn.

The arrangement of the adaptation apparatus between the hollow conductor and the antenna horn may mean that the adaptation apparatus may be arranged in such a way that part of the adaptation apparatus may project into the antenna horn while another part of the adaptation apparatus may project into the hollow conductor.

According to a further aspect of the present invention, a measuring device may be provided which may comprise an antenna arrangement according to the invention.

According to a further aspect of the present invention, a method for closing off a waveguide may be created. In this method a closing-off body may be arranged in the waveguide in such a way that a generated surface of the closing-off body may establish contact with the external conductor of the waveguide. Furthermore, an enlargement may be arranged on the generated surface of the closing-off body. By this enlargement an electrical short circuit may be spaced apart at a distance from the generated surface, i.e. the short circuit may be kept at a distance of the generated surface.

The short circuit, which may be transformed from the enlargement to the generated surface, may be formed by an external conductor of the hollow conductor, which may encompass the enlargement continuously, i.e. without interruption or without a gap.

The short circuit may be in contact with the enlargement. Since the short circuit may be to be spaced apart by the enlargement, the enlargement may be designed in such a way that the enlargement may essentially space apart the short circuit without any mechanical pressure being exerted on the enlargement.

The short circuit may be formed respectively built in the external conductor of the hollow conductor, and in the case of a particular selection of a space, for example in the case of a multiple of half the wavelength of a wave that may be transmitted respectively conducted in the waveguide, the short circuit may be transformed to a short circuit on the generated surface of the closing-off body. The short circuit may also be spaced apart at a distance of λ/2 from the generated surface. This may mean that the enlargement may keep the short circuit at a distance of λ/2 or a multiple of λ/2 from the generated surface.

In other words, the short circuit may be formed in the external conductor of the hollow conductor. The short circuit may be an apparent short circuit to the HF. In the case of a particular selection of a space, for example in the case of a multiple of half the wavelength of a wave that may be transmitted in the waveguide, the short circuit may be transformed to an apparent short circuit on the generated surface of the closing-off body.

The closing-off body may be conically formed or cylindrically formed and may make possible mechanical separation between two spaces. For example, the closing-off body may mechanically separate an internal space of a container from an external space of a container. In this way, for example, diffusion of a substance and material, respectively between two spaces may be prevented.

The short circuit may encompass the closing-off body, in particular the enlargement, in a continuous manner. In other words, this may mean that the waveguide near the enlargement essentially does not comprise a gap, and in particular, that the waveguide is made in one piece. For example, the waveguide may be a block of a conductive material such as metal.

Waveguides can be designed as hollow conductors or wave ducts. Waveguides can also comprise an antenna horn. By means of the waveguide an electromagnetic wave may be fed respectively led to an internal space of a reservoir or a container. If the conditions in the internal space of the container may differ from those in the external space, separation of the conditions can be maintained by means of an adaptation apparatus.

For example, a concentration difference of a material between an internal space of a container and an external space of a container may essentially be maintained. Corrosive liquids or gases may be able to be separated from the external space, or different pressures in the internal space and the external space of the container may be able to be maintained. Furthermore, ex-protection (explosion-proofness) specifications or guidelines may be complied with.

The enlargement may be designed as a radial enlargement, i.e. the enlargement may extend essentially at a right angle to the longitudinal axis of the adaptation apparatus. As a result of the small dimensions of the adaptation apparatus the space on the radial enlargement may not be adequate for accommodating one, two or a plurality of seals at a position in the waveguide, which position is to be sealed accordingly.

The adaptation apparatus may be in place in a waveguide. The enlargement may make it possible to increase the area and surface, respectively to which a seal, such as an O-ring, can be affixed, without the adaptation apparatus significantly interfering with the wave propagation in the hollow conductor.

To this effect the adaptation apparatus may transform a short circuit that is apparent to the HF at the end of the enlargement to a short circuit at the generated surface of the adaptation apparatus. Thus the electromagnetic wave may not “see” the enlargement to which the seal has been affixed. In order to keep the reflections at the transition locations as low as possible, an impedance converter may be arranged on the adaptation apparatus. A tip of a cone and a peak of a cone, respectively may be one embodiment of an impedance converter. In an example the impedance converter may be realized as a tip of a cone. The realisation as a tip of a cone may reduce the reflections at the transition from the material in the hollow conductor, e.g. air, to the material of the adaptation apparatus, e.g. PTFE.

For example, the wavelength which may have to be transmitted by the waveguide may be 2.62 mm in the W-band at 79 GHz in PTFE (polytetrafluoroethylene). An enlargement or a collar whose radial extent may be a multiple of λ/2 may be wider than 1.31 mm on the cone, i.e. on the generated surface of a conical or cylindrical adaptation apparatus. The radial extent may essentially be at a right angle to the longitudinal axis of the adaptation apparatus. An O-ring, which for sealing in axial direction of the waveguide may be arranged in front of or behind the collar, may be easily affixable and may according to the rules of high-frequency technology (i.e. in a HF technical way) reduce the interference influences on the propagation of a high-frequency wave.

In order to achieve a predetermined sealing effect, the cord thickness (Schnurstaerke) of an O-ring can be varied. “Cord thickness” may refer to the diameter of the part of an O-ring that is filled with substance and material, respectively.

The axial arrangement of an O-ring on the enlargement may simplify installation of the O-ring when compared to a radial arrangement of the O-ring. By the axial arrangement or the axial installation of the O-ring, it may be prevented that the O-ring may be stretched open too far or too wide, respectively until the O-ring may be installed.

Furthermore, the axial arrangement of the O-ring may prevent the O-ring having to be selected so as to be large in relation to the hollow conductor. This may prevent the signal path of the HF wave from being interfered with by the sealing, and may prevent the occurrence of interfering reflections.

The W-band may be the range of the electromagnetic spectrum that extends from 75 to 110 GHz (gigahertz).

A frequency at which an electromagnetic wave may be transmitted may be interpreted as being a frequency band. For example, a transmission frequency of 79 GHz may mean that an electromagnetic wave may be transmitted at a centre frequency of 79 GHz, and may comprise a bandwidth of, for example, ±2 GHz around the centre frequency. A frequency band may be a range of frequencies.

Information in this document that may refer to λ, λ/2 or λ/4 may assume to be related to a centre frequency of a frequency band, and in particular to a wavelength that may be associated with this centre frequency.

It would also be imaginable that the adaptation apparatus may be suitable for use in the K-band, i.e. from 23 GHz-27 GHz.

According to a further aspect of the present invention, an adaptation apparatus may be created, wherein the space at which the short circuit may be kept by the adaptation apparatus may exceed λ/2. In other words, the space or distance may be greater than λ/2.

At small wavelengths the adaptation apparatus may be able to be dimensioned in such a way that a sealing, for example an O-ring, can be arranged on the enlargement. In the case where small wavelengths are used, the adaptation apparatus may be dimensioned such that the sealing can be arranged at the enlargement.

According to a further aspect of the present invention, the space may be an integral multiple of λ/2.

A short circuit that may be kept spaced apart from the generated surface, which space corresponds to an integral multiple of λ/2, may also be transformed to an apparent short circuit on the generated surface, like a short circuit at a space, which space essentially may correspond to λ/2. The effect of a space of λ/2 may essentially correspond to the effect of a space of an integral multiple of λ/2.

According to another exemplary embodiment of the present invention, an angle of 90° may be formed between the generated surface of the closing-off body and the enlargement.

The form of the closing-off body may thus be a cylinder form or a rectangular form that can be arranged in a round hollow conductor and in a rectangular hollow conductor, respectively.

According to yet another exemplary embodiment of the present invention, an obtuse angle may be formed between the generated surface of the closing-off body and the enlargement.

The shape of the closing-off body may thus be a conical shape which can be arranged in a hollow conductor of any desired cross section.

According to a further aspect of the present invention, an adaptation apparatus may be created that comprises a seal, a sealing or a sealing arrangement, wherein the seal is arranged in front of and/or behind the enlargement when viewed in the direction of propagation of an electromagnetic wave.

The enlargement may represent an attachment option for the seal.

According to another aspect of the present invention, the seal may rest against the enlargement.

The seal, sealing arrangement or the O-ring may rest against the enlargement. The seal may thus be in contact with the enlargement. As a result of this contact the sealing effect may be increased. A flow of substance and a flow of material, respectively along the enlargement in the direction of the longitudinal axis of the adaptation apparatus may essentially be suppressible.

According to yet another aspect of the present invention, the seal may rest against the generated surface.

The seal resting against the generated surface may essentially suppress a material stream along the generated surface in a direction parallel to the longitudinal axis of the adaptation apparatus.

According to yet another aspect of the present invention, the generated surface of the closing-off body may be selected from the group of generated surfaces consisting of a cone surface, a cylinder surface, a rectangle surface and a pyramid surface.

Any combination of the generated surfaces may be imaginable, too. The various shapes may allow adapting the closing off body to the shape of the waveguide. Furthermore, the shapes may essentially reduce reflections of electromagnetic waves.

According to another aspect of the present invention, the adaptation apparatus in a non-compressed state or in a relaxed state comprises a radial enlargement whose length may essentially be λ/2.

When the enlargement may have a length of λ/2 the enlargement may keep the short circuit at a space of λ/2 and at a distance of λ/2, respectively even if the space of the short circuit were to be enlarged or reduced by an external force without the presence of the enlargement. The enlargement may thus also serve as a support that maintains the space of λ/2. The length of the enlargement may be λ/2 also in the installed state. As a result of these measures the space of λ2 may be able to be set more precisely.

Many improvements and further developments, respectively of the invention may have been described with reference to the adaptation apparatus. These embodiments may also apply to the antenna arrangement, the measuring device and the method for closing off a waveguide.

It should be noted that different aspects of the invention have been described with reference to different subject-matters. In particular, some aspects have been described with reference to apparatus type claims, whereas other aspects have been described with reference to method-type claims. However, the skilled person can see from the above description and from the description below that, unless otherwise described, additional to each combination of features which belong to a category of subject-matters, any combination of features that relate to different categories of objects should be considered to be disclosed. In particular, combinations of features of apparatus type claims with features of method type claims are also disclosed.

According to a further aspect of the present invention, the measuring device may be selected from the group of measuring devices consisting of a fill-level measuring device, flow-through measuring device, pressure measuring device, a radar measuring device, a measuring device based on the principle of the guided microwave, a fill-level radar which operates in pulse mode or as an FMCW (frequency-modulated continuous wave) device, a delay measuring device and a transit-time measuring device (Laufzeitmessgerät).

By means of an axial arrangement of a sealing ring, antenna systems or antenna arrangements for a fill-level radar may be built that in spite of their compact design and small dimensions, respectively combine good sealing characteristics with good electrical characteristics.

The small design may be caused by the high frequency of an electromagnetic wave that is used.

As far as the electrical characteristics are concerned, lower performance losses of the echo amplitude when compared to those with radially affixed O-rings may be achieved. Furthermore, any tendency to “antenna ringing” (Antennenklingeln) or “ringing” may be low because the sealing ring may be arranged outside the direct signal path of the electromagnetic wave, and thus the influence of the material characteristics and of the material properties, respectively of the sealing ring may be reduced. “Ringing” may essentially be caused by undesired reflections on the sealing ring, but it can, for example, already arise at transition locations within the antenna (for example between the PTFE tip and the air-HL (air-hollow conductor)). Antenna ringing may be interference caused by reflections at an end of the antenna.

It may not be necessary to use special materials for hollow conductor and adaptation cones, but instead, for example, commonly used materials such as steel and PTFE can be used. Hollow conductors and adaptation cones may thus be producible simply and economically as turned parts. Thanks to the applied construction of the adaptation cone, commercially available sealing rings of any materials may be usable. Installation of an antenna arrangement according to the invention may be easy and may be able to be carried out without a special tool (e.g. a press tool).

### BRIEF DESCRIPTION OF THE DRAWINGS

Below, advantageous exemplary embodiments of the present invention are described with reference to the figures:

FIG. 1 shows a lateral view of an adaptation apparatus according to an exemplary embodiment of the present invention.

FIG. 2 shows a lateral view of a further adaptation apparatus according to an exemplary embodiment of the present invention.

FIG. 3 shows a longitudinal section of an antenna arrangement with the adaptation apparatus of FIG. 2, according to an exemplary embodiment of the present invention.

FIG. 4 shows a longitudinal section of an antenna arrangement with the adaptation apparatus of FIG. 1, according to an exemplary embodiment of the present invention.

FIG. 5 shows a perspective view of the antenna arrangement of FIG. 4, according to an exemplary embodiment of the present invention.

FIG. 6 shows a longitudinal section of a further antenna apparatus with the adaptation apparatus of FIG. 2, according to an exemplary embodiment of the present invention.

FIG. 7 shows an antenna arrangement in which the collar of an adaptation element has been pressed onto (verpresst) the flange of an antenna horn, according to an exemplary embodiment of the present invention.

FIG. 8 shows the antenna arrangement of FIG. 7, wherein between the collar of the adaptation element and the flange of the antenna horn a disc is arranged according to an exemplary embodiment of the present invention.

### DETAILED DESCRIPTION OF EXEMPLARY EMBODIMENTS

The drawings in the figures are schematic respectively diagrammatic and not-to-scale. In the following description of FIGS. 1 to 8 the same reference numerals are used for identical or corresponding elements.

FIG. 1 shows a lateral view of an adaptation apparatus 100. The adaptation apparatus 100 is not only adapted for separating two spaces, e.g. an internal space and an external space of a container; but the adaptation apparatus 100 is also adapted to effect little influence on an electromagnetic wave. Since little influencing of an electromagnetic wave, in particular of a high-frequency electromagnetic wave (HF-wave), is achievable if the adaptation apparatus 100 comprises conical ends or tapering ends, the adaptation apparatus 100 is also referred to as an adaptation cone 100.

The adaptation apparatus 100 can be a rotationally-symmetrical turned part that is, for example, made of PTFE. In the case of rotational symmetry, the rotational axis may be parallel to the longitudinal axis of the adaptation apparatus 100. The adaptation apparatus 100 further comprises a first conical end 103 and a second conical end 104. The two conical ends are arranged on the circular collar 101, on the ring-shaped enlargement 101 or on the circular flange 101 with their bases or with their base areas, wherein in the case of single-piece production the bases are no longer recognisable.

The first conical end 103 and the second conical end 104 form, for example, a closing-off body.

The enlargement 101 is an HF choke 101 and the enlargement 101 is used in order to affix respectively to mount a seal in axial direction. By means of the axial seal a small sealing effect that the enlargement 101 may achieve on its own may be increased.

In other words, the enlargement 101 essentially blocks a flow of a fluid along the generated surface 102, 107 of the two conical ends 103, 104. In order to prevent a fluid from being able to spread around the enlargement, a seal is arranged in axial direction on the enlargement 101. In particular, for sealing on the enlargement 101 a seal, for example an O-ring, is arranged. However, in FIG. 1 the seal is not shown.

The enlargement 101 may increase the area to which a seal can be affixed. In an installed state the seal may come to rest between the enlargement and a waveguide or the external conductor of a waveguide. If the seal is jammed by pressure between the enlargement 101 and the waveguide, the sealing effect of the seal may be increased.

The bases of the two conically shaped ends 103, 104 follow on directly from the enlargement 101. I.e. the bases of the two conical ends 103, 104 are directly joined to the enlargement 101. The enlargement is arranged at a right angle to the longitudinal axis of the adaptation apparatus 100. Thus respective angles 105, 106 result between the conical ends 103, 104 and the enlargement 101, which angles 105, 106 exceed 90°, i.e. are obtuse angles.

In order to increase the sealing effect, in axial direction in front of or behind the collar 101 a sealing ring, for example an O-ring, can be arranged firmly fitting to the collar 101. In other words, the sealing can be arranged so as to rest firmly against the collar 101.

The enlargement 101 has a space w, a distance w or a length w from the outermost generated surface of the base of the first conical end 103 of more than λ/2. Thereby, λ denotes the wavelength of an electromagnetic wave which also, like the fluid, propagates essentially parallel to the symmetry axis of the adaptation apparatus. The length w can be any multiple of λ/2. Depending on the direction of view from which the enlargement 101 is viewed, the extent w of the enlargement can be designated the width w or length w. In a direction perpendicular to the longitudinal axis of the adaptation apparatus 100, the enlargement 101 may have the length w. When viewed in longitudinal direction, the enlargement 101 may have the width w.

In this arrangement the width w, the length w or the radius w may be selected such that an apparent short circuit to the HF, which apparent short circuit is located at the end of the enlargement 101, which end is furthest away from the longitudinal axis of the adaptation apparatus, is transformed to an apparent short circuit on the outermost generated surface of the first conically shaped end 103 or generally on the outermost generated surface of the closing-off body. As a result of this transformation, essentially interference-free propagation of an electromagnetic wave may take place because the HF choke 101 in the corresponding frequency band or at a corresponding centre frequency is practically essentially not visible respectively invisible to HF and therefore essentially causes no interference, or at least only little interference as a result of reflections.

The thickness h of the enlargement 101 in axial direction relative to the longitudinal axis of the adaptation apparatus is λ/4 or a value very close to λ/4 (λ/4 plus/minus 10%, i.e. from 0.9 λ/4 to 1.1 λ/4). Other values, e.g. 3 λ/4 or still other values are imaginable, however, certain interference can then occur in the form of reflections and/or attenuation. The shape of the enlargement 101 can be ring-shaped, rectangular, polygonal or oval.

As an alternative, the first conically shaped end 103 or the second conically shaped end 104 can be pyramid-shaped. If the adaptation apparatus 100 is used for a rectangular hollow conductor, the base area of the first conically shaped end and of the second conically shaped end can correspond to the shape of the rectangular hollow conductor. The dimensions can depend on the wavelength λ. In the case of a round hollow conductor the base area or the closing-off body 102, 107 can be round.

In the arrangement according to FIG. 1, the adaptation apparatus 100 is shaped in such a way that the adaptation apparatus 100 essentially does not interfere from a HF-technical view, and that the antenna system can nevertheless efficiently be sealed. As a result of the enlargement 101 of the adaptation apparatus in the form of a collar 101, sealing takes place at said collar 101 so that the seal essentially does not interfere in the actual signal path. In other words, the S-parameter S₁₁, i.e. reflection attenuation or return-flow attenuation, may have a low value.

The space from the tip or from the peak of the first conically shaped end 103 to the base of the first conically shaped end 103 is smaller than the space from the tip or from the peak of the second conically shaped end 104 and the base of the second conically shaped end 104. Consequently the angle at the tip of the first conically shaped end 103 is more obtuse than the angle at the tip of the second conically shaped end 104.

The adaptation apparatus 100 according to the present invention also makes it possible for an antenna system to be sealed efficiently even in the W-band, without significantly influencing the HF.

The enlargement 101 is not limited to λ/2; instead it can also exceed λ/2. The enlargement can, for example, also be a multiple of λ/2.

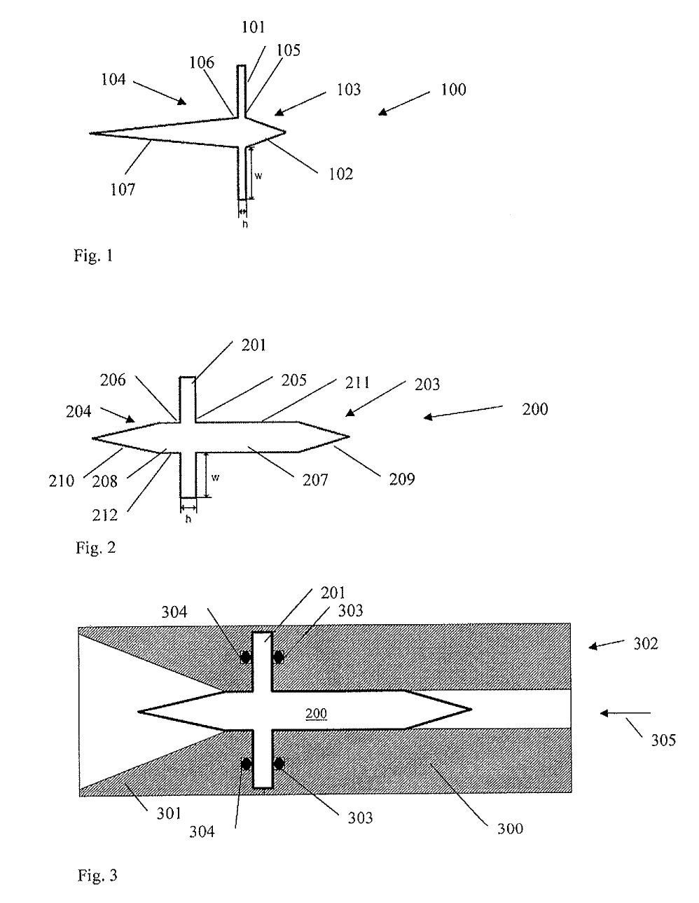

FIG. 2 shows a further adaptation apparatus 200. As far as the adaptation cone 200 or the adaptation apparatus 200 is concerned, the description of the adaptation cone 100 of FIG. 1 essentially applies. The adaptation cone 200, too, comprises a first conically shaped end 203 and a second conically shaped end 204. Likewise the flange 201, the enlargement 201, the shoulder 201 or the collar 201 can be recognized, which is arranged between the two conically shaped ends 203, 204.

In contrast to FIG. 1, from FIG. 2 additionally it can be recognized that between the flange 201 and the first conically shaped end 201 the first cylinder region 207 of the closing-off body is arranged. Furthermore it can be recognized that between the second conically shaped end 204 and the flange 201 the second cylinder region 208 of the closing-off body is arranged. In other words this means that in each case the closing-off body comprises a cylinder region 207, 208 and a conically shaped end 201, 204.

The closing-off body is designed as a solid body.

Between the generated surface 211 of the first cylinder region 207 and the enlargement 201 a first right angle 205 can be recognized. Between the generated surface 212 of the second cylinder region 208 and the enlargement 201 the second right angle 206 can be recognized.

The enlargement 201 extends along the length w or across the width w, which is λ/2 or a multiple of λ/2.

The shape 211 of the generated surface of the first cylinder region 207 and the shape of the generated surface 212 of the second cylinder region 208 can be adapted to the shape of a hollow conductor. Furthermore, the shape of the generated surface 211 of the first cylinder region 207 and the shape of the generated surface 212 of the second cylinder region 208 can be adapted to the shape of the base of the first conically shaped end 203. Thus an essentially continuous transition between the generated surface 209 of the first conically shaped end 203 and the generated surface of the first cylinder region 207, as well as between the generated surface 210 of the second conically shaped end 204 and the generated surface of the second cylinder region 208 is possible.

The first cylinder region 207 and the second cylinder region 208, respectively can, independently of each other, be a regular cylinder respectively a circular cylinder or a rectangular cylinder.

The first cylinder region 207 is longer than the second cylinder region 208.

The adaptation apparatus 100 as well as the adaptation apparatus 200 can be configured in one part, in a single part or in several parts. In the case of a single-part construction the adaptation apparatus 100, 200 is, for example, produced as a turned part or an injection part.

In the case of a two-part construction, the two halves are separated or cut apart along a perpendicular separation plane to the longitudinal axis of the adaptation apparatus 100, 200. In this arrangement the separation plane can extend through the enlargement 101, 201, can be situated between the enlargement 101, 201 and the first conically shaped end 103, 203, or can be situated between the enlargement 101, 201 and the second conically shaped end 103, 203.

FIG. 3 shows a longitudinal cut through an antenna arrangement 302 with the adaptation apparatus 200 of FIG. 2. FIG. 3 shows the way the adaptation cone 200 is built into an antenna system 302.

The antenna system 302 or the antenna arrangement 302 comprises the hollow conductor 300 and the antenna horn 301. The antenna horn 301 comprises a funnel-shaped enlargement. The antenna horn 301 can comprise a rectangular or round cross section. The hollow conductor 300, in particular the external conductor 300 of the hollow conductor, the antenna horn 301 and the adaptation apparatus 200 can be rotationally symmetrically built. The associated symmetry axes extend parallel to the longitudinal axis of the adaptation apparatus 200 and essentially determine the direction of propagation of an electromagnetic wave.

Generally speaking, in this document the term “direction of propagation” may refer to the direction of a wave, which direction is directed towards a material and a good, respectively, wherein the distance from the good is to be measured. In the direction that is opposite this direction a reflected wave may travel. In FIG. 3 the direction of propagation is designated by the arrow 305.

Both the antenna horn 301 and the hollow conductor 300 are filled with air. However, any desired material, in particular any desired dielectric material, can be used for filling.

The adaptation device 200 and adaptation apparatus 200, respectively, in particular by means of the enlargement 201 and by means of the closing-off body, essentially blocks the connection between the antenna horn 301 and the hollow conductor 300 to penetration by a fluid. The first conically shaped end 203 projects into the hollow conductor 300 and the second conically shaped end 204 projects into the antenna horn 301. The shape of the adaptation apparatus 200 is adapted such that in the case of an arrangement of the adaptation device 200 in the antenna arrangement 302 reflection arises as low as possible, i.e. that the S₁₁ value or S₁₁ wave parameter is as low as possible, while the width w of the collar 201 or the width w of the collar measured from the generated surface 211, 212 of the closing-off body has a multiple of λ/2. One example of a value of the S-parameter S11 is −20 dB. At this value, essentially only a hundredth of the fed-in power may be reflected back.

Expressed as an equation this means that

w=nλ/2; n=2, 3, 4, 5, 6, . . . or w=nλ/2; n=1, 2, 3, 4, 5, 6, . . . .

The collar width w, i.e. the radial expansion of the enlargement 101, 201 can exceed λ/2. In particular, the collar width w can also be a multiple of λ/2. The enlargement 201, 101 can also be referred to as a radial enlargement. In axial direction the radial enlargement has a thickness h. The thickness h of the radial enlargement can be in the range of λ/4.

For reasons of diffusion density it can, for example, be necessary to select the thickness of the collar 101, 201 so that it is thicker than λ/4, wherein care is to be taken that the S₁₁ parameter is still below a predetermined maximum value.

The sealing ring 303, 304 or the sealing rings 303, 304 can be mounted either in front of or behind the collar 101, 102, the enlargement 101, 102 or the HF choke 101, 102. It is also imaginable to mount a single seal 303, 304 or several seals 303, 304 in front of or behind the expanded section 201.

Any commonly used types of seals are imaginable for sealing, for example, one, a single, two or several O-rings. For example, an O-ring can also be arranged in a notch in one of the conical ends 102, 107, 209, 210, on the first cylinder region 207 in a notch, and/or on the second cylinder region 208 in a notch. A notch can, for example, be designed as a groove, narrowing or recess.

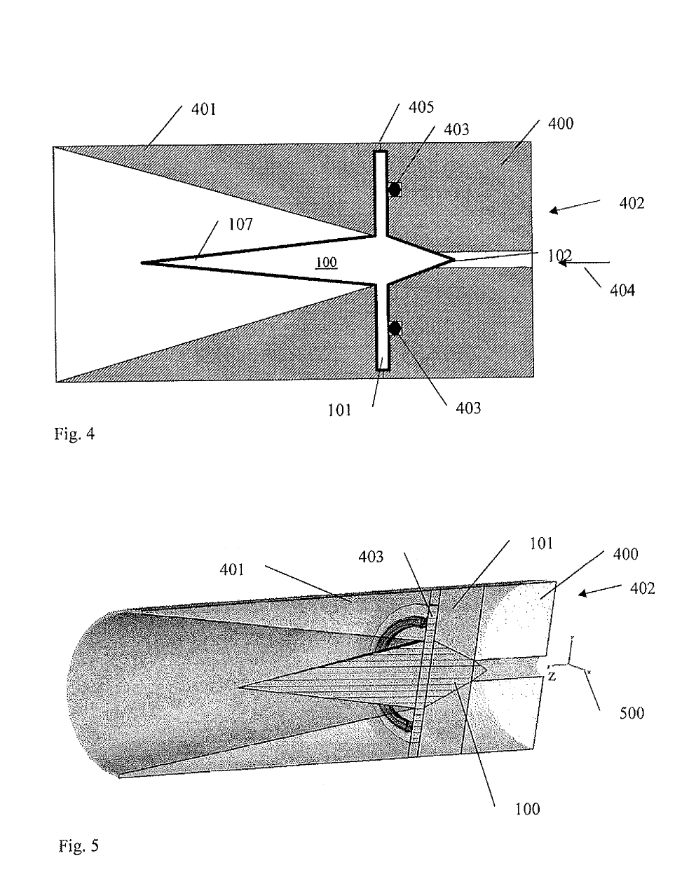

FIG. 4 shows a longitudinal section of an antenna arrangement 402 with the adaptation apparatus 100 or the adaptation cone 100 from FIG. 1.

A wave propagation direction, or the direction of the longitudinal axis is indicated by the arrow 404.

Similar to FIG. 3, in FIG. 4 the adaptation apparatus 100 is arranged between the hollow conductor 400 and the antenna horn 401.

The longer second conically shaped end 107 projects into the funnel-shaped antenna horn 401, while the shorter first conical end 102 projects into the hollow conductor 400.

The hollow conductor 400 and the antenna horn 401 are filled with air; however they can be filled with any desired dielectric material. Between the hollow conductor 400, in particular the external conductor 400 of the hollow conductor and the antenna horn 401, there may be formed a gap 405. This gap may facilitate or may ease installation and de-installation of the antenna arrangement 402 for assembly and disassembly of the adaptation apparatus 100. However, in the installed state the gap 405 may be so small that essentially a short circuit for an electromagnetic wave of a predetermined frequency can arise.

The antenna arrangement 302, 402 is arranged in an installed state on an external wall of the container in such a way that the funnel-shaped antenna horn 401 projects into the interior of the container, and the hollow conductor 300, 400 projects from the container so that a further conductor, in particular a further hollow conductor, can be connected to the hollow conductor 300, 400. This further conductor can, for example, be used to feed waves to the hollow conductor, or it can be used as an HF injection (HF Einkopplung) and input coupling, respectively.

The HF-signal of the microwave module is coupled respectively injected into the hollow conductor. As a rule, the hollow conductor is stimulated in the base mode so that essentially only one mode is able to propagate. I.e. essentially only a single mode is able to propagate. In the case of the round hollow conductor this is the H₁₁ mode.

The cross-sectional area of the first cylinder region 207 or of the second cylinder region 208 or the base area or the base of the first conically shaped end 103, 203 or the base area and base surface, respectively of the second conically shaped end 104, 204 is aligned to the dimensions of the hollow conductor 300, 400. The cross-sectional area or the base area thus depends on the wavelength λ that is to be transmitted in the hollow conductor 300, 400.

FIG. 5 shows a perspective view of the antenna arrangement of FIG. 4, according to an exemplary embodiment of the present invention. The diagram shows the generated surface of the funnel-shaped antenna horn 401 can be recognized that forms the continuation of the hollow conductor 400.

The antenna arrangement 402 can be regarded as a waveguide. The waveguide can comprise an antenna horn 401 and a hollow conductor 400.

FIG. 5 also shows the axial arrangement of the sealing ring 403 on the enlargement 101 can be seen. The coordinate system 500 shows that the longitudinal axis of the adaptation apparatus 100 extends through the tips of the adaptation apparatus in the z-direction. In this diagram the z-axis also denotes the direction of the longitudinal axis of the adaptation apparatus.

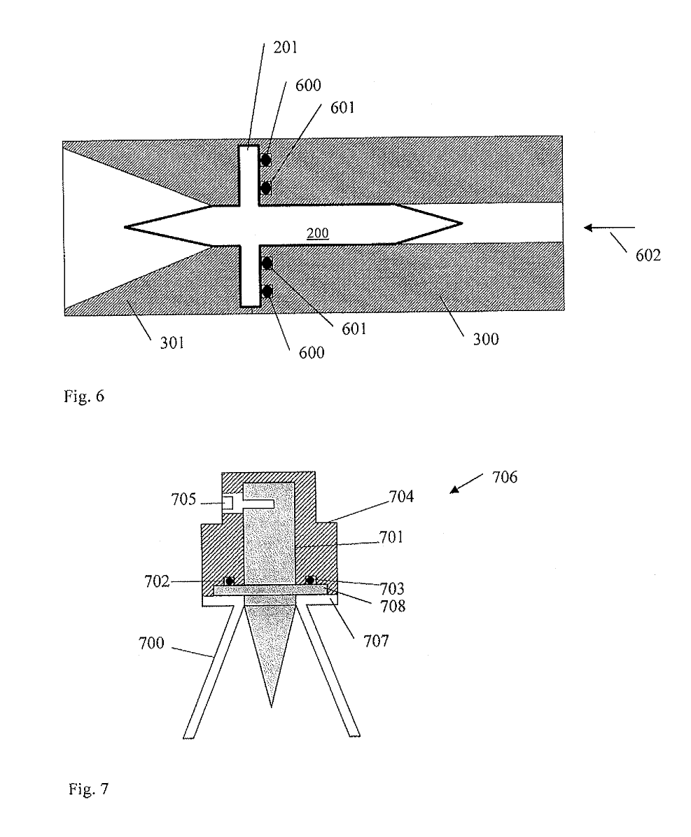

FIG. 6 shows a longitudinal section of a further antenna arrangement 602 with the adaptation apparatus 200 of FIG. 2. Similar to FIG. 3 the adaptation apparatus 200 is shown arranged in the hollow conductor 300 and in the antenna horn 301. On the enlargement 201 on the same side the first sealing ring 600 and the second sealing ring 601 are arranged.

In order to arrange the first sealing ring 600, in the external conductor 300 of the hollow conductor a rectangular recess or groove is installed which comprises smaller dimensions than the cord thickness of the first sealing ring 600 so that the first sealing ring 600 is compressed. Likewise, around the second sealing ring 601 a second rectangular recess is formed in the hollow conductor 300, which recess accommodates the second sealing ring.

Antenna systems or antenna arrangements 302, 402 should be arranged in such a way that they comprise good impedance matching of electrical transitions, for example the transition between a connection line or HF feed and a hollow conductor 300, 400; between a hollow conductor 300, 400 and an antenna 301, 401; or between antenna 301, 401 and air, in order to obtain interference reflection as low as possible.

Furthermore, an antenna arrangement 302, 402 should be adapted in such a manner as to make possible essentially complete sealing of a container to the outside.

As the frequency increases (>6 GHz) the requirements concerning antenna arrangements can possibly be met only with difficulty. Arrangements comprising radial sealing rings on the adaptation cone 100, 200 of the antenna feed-in and antenna input coupling, respectively can comprise performance losses in these frequency ranges. The performance losses and power losses, respectively can be caused in that the dimensions of the mechanical parts such as hollow conductor 300, 400, adaptation cone 100, 200 etc. become progressively smaller when increasing the frequency. At the same time a sealing ring (O-ring) 304, 303, 403 should be adapted in such a way that it has a particular cord thickness and thus ensures a reliable sealing.

Despite the reduction in the wavelength in the region of higher frequencies, the size of a sealing ring and thus the size of the recess (Einstich) remains unchanged. As a result of the reduction in the wavelength in the region of higher frequencies, the recess or the groove in which a sealing ring 304, 303, 403 is arranged relative to the diameter of the cylinder 207, 208 of the adaptation cone 100, 200 already becomes such large that the recess can interfere with the propagation of the electromagnetic wave. Depending on the material characteristics and the material properties, respectively of the sealing ring, the echo amplitude of an electromagnetic wave can be attenuated. Furthermore, “ringing”, i.e. an undesirable reflection, can make itself felt.

A hollow conductor 300, 400 with an adaptation cone 100, 200 in which the sealing ring 303, 304, 600, 601 is axially attached can reduce attenuation of the echo amplitude or “ringing”. In an axially attached O-ring 303, 304, 600, 601 the O-ring with its partly negative electrical characteristics is essentially outside the direct signal path of an electromagnetic wave.

In order to implement an arrangement of the sealing ring 303, 304, 600, 601 outside the signal path, a thickened section 101, 201 or an enlargement 101, 201 at the adaptation cone 100, 200 can be used. The thickness h of this widened section should be in the range of λ/4. At the position of the thickened section 101, 201, the radius of the adaptation cone 100, 200 is increased by w=λ/2 or by a multiple of λ/2.

FIG. 7 shows an antenna arrangement 706 in which the adaptation element 701, in particular the collar 708 of the adaptation element 701, or a seal 703 that is arranged on the collar 708 of the adaptation element, is pressed together with the flange 707 of the antenna horn 700. The adaptation cone 701 comprises a rectangular end and a pointed end, wherein the rectangular end is adapted to accommodate the HF input coupling (high-frequency input coupling) 705.

The adaptation cone 701 can be made from any material with dielectric properties. The sealing ring 703, which is arranged in the ring-shaped groove 702, can consist of any materials commonly used in sealing rings. For example, elastomers can be used in the production of the sealing rings 303, 304, 403, 600, 601, 703. Elastomers are elastic materials. As a result of the axial arrangement of the sealing ring it is, however, possible to use non-elastic sealing rings 303, 304, 403, 600, 601, 703 or rigid sealing rings 303, 304, 403, 600, 601, 703, e.g. made of metal or FEP (perfluoroethylene propylene copolymer) encased elastomers.

The recess 702 or the groove 702 for the sealing ring 703 is made in the hollow conductor in such a way that the O-ring 703 used is approximately situated in the middle of the thickened part 708, in particular in the middle of the length w of the thickened part 708 (Verdickung), and rests against the inside of the hollow conductor 704 in such a way that the sealing ring 703 seals towards the rear (i.e. in the direction of the HF input coupling 705).

In the antenna arrangement 706 of FIG. 7 the O-ring 703 is directly pressed together with the flange 707 of the antenna horn 700.

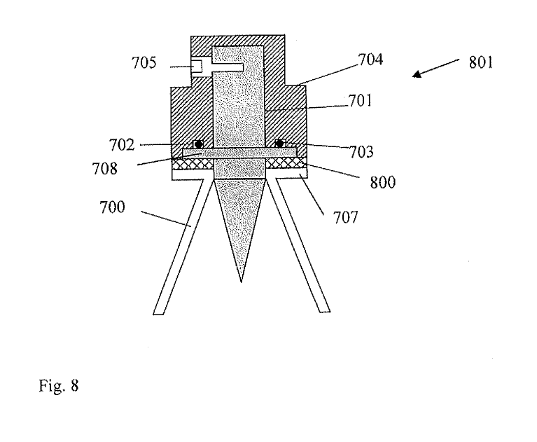

FIG. 8 shows an antenna arrangement 801 in which a disc 800 is arranged between the hollow conductor 704 and the antenna horn 700. In contrast to FIG. 7, in FIG. 8 there is a disc 800 available. The disc 800 is arranged between the collar 708 of the adaptation element 701 and the flange 707 of the antenna horn 700.

In the antenna arrangement 801 the O-ring 703 is pressed (verpresst) with the aid of an additional disc 800, for example a metal ring 800, which disc 800 is attached to the hollow conductor 704 by means of countersunk screws. In other words, the O-ring 703 is pressed into the groove 702 of the hollow conductor 704 by pressure that is exerted by the enlargement 708. The pressure of the enlargement 708 is generated by a disc 800 that is pressed against the enlargement 708 by means of countersunk screws (not shown in FIG. 8). In this way the adaptation cone 701 is secured against falling out. During a change of the antenna horn 700, the danger of the adaptation cone 701 falling out of the hollow conductor 704 can be reduced.

In addition, it should be pointed out that “comprising” does not exclude other elements or steps, and “a” or “one” does not exclude a plurality. Furthermore, it should be pointed out that characteristics or steps which have been described with reference to one of the above exemplary embodiments can also be used in combination with other characteristics or steps of other exemplary embodiments described above. Reference numerals in the claims are not to be interpreted as limitations.

What is claimed is:

1. An adaptation apparatus, comprising:
a closing-off body, including a generated surface, the generated surface being adapted to establish contact with an external conductor of a waveguide; and
an enlargement being arranged on the generated surface, the enlargement being adapted such that the enlargement spaces apart an electrical short circuit at a predetermined space from the generated surface.

2. The adaptation apparatus of claim 1, wherein the space exceeds λ/2.

3. The adaptation apparatus of claim 2, wherein the space is an integral multiple of λ/2.

4. The adaptation apparatus of claim 1, wherein an angle of 90° is formed between the generated surface and the enlargement.

5. The adaptation apparatus of claim 1, wherein an obtuse angle is formed between the generated surface and the enlargement.

6. The adaptation apparatus of claim 1, further comprising:
a seal arranged at least one of (a) in front of and (b) behind the enlargement in a direction of propagation of an electromagnetic wave.

7. The adaptation apparatus of claim 6, wherein the seal is arranged so as to rest against the enlargement.

8. The adaptation apparatus of claim 6, wherein the seal is arranged so as to rest against the generated surface.

9. The adaptation apparatus of claim 1, wherein the generated surface is selected from the group of generated surfaces consisting of a cone surface, a cylinder surface, a rectangle surface and a pyramid surface.

10. An antenna arrangement, comprising:
a hollow conductor;
an antenna horn; and
an adaptation apparatus including a closing-off body and an enlargement, wherein the closing-off body including a generated surface which is adapted to establish contact with an external conductor of a waveguide, the enlargement being arranged on the generated surface, the enlargement being adapted such that the enlargement spaces apart an electrical short circuit at a predetermined space from the generated surface,
wherein the adaptation apparatus is arranged between the hollow conductor and the antenna horn.

11. A measuring device, comprising:
an antenna arrangement including a hollow conductor, an antenna horn and an adaptation apparatus, the adaptation apparatus including a closing-off body and an enlargement;
wherein the closing-off body includes a generated surface which is adapted to establish contact with an external conductor of a waveguide, the enlargement being arranged on the generated surface, the enlargement being adapted such that the enlargement spaces apart an electrical short circuit at a predetermined space from the generated surface and
wherein the adaptation apparatus is arranged between the hollow conductor and the antenna horn.

12. The measuring device of claim 11, wherein the measuring device is selected from the group of measuring devices consisting of a fill-level measuring device, flow-through measuring device, pressure measuring device, a radar measuring device, a measuring device based on the principle of the guided microwave, and a transit-time measuring device.

13. A method for closing off a waveguide, comprising:
arranging a closing-off body in the waveguide such that a generated surface of the closing-off body establishes contact with an external conductor of the waveguide;
arranging an enlargement on the generated surface; and
spacing apart, by the enlargement, an electrical short circuit at a distance from the generated surface of the closing-off body.
